(19) United States
(12) Patent Application Publication
(10) Pub. No.: US 2012/0209949 A1
(43) Pub. Date: Aug. 16, 2012

(54) METHODS AND APPARATUS TO MONITOR MEDIA CONTENT

(76) Inventors: Alexandros Deliyannis, Tampa, FL (US); Arun Ramaswamy, Tampa, FL (US); Jan Besehanic, Tampa, FL (US)

(21) Appl. No.: 13/221,481

(22) Filed: Aug. 30, 2011

Related U.S. Application Data
(60) Provisional application No. 61/442,758, filed on Feb. 14, 2011.

(51) Int. Cl. G06F 15/16

(52) U.S. Cl. 709/217

(57) ABSTRACT

Methods and apparatus to monitor media content at a content display site are described. An example method includes transmitting a meter to a content provider, the meter implemented by computer readable instructions to be executed with a media content player when media content is presented by the media content player, the meter to at least one of generate a signature for the media content and extract a code from the media content; and transmit at least one of the signature and the code to a media monitoring entity

### FIELD OF THE DISCLOSURE

The present disclosure relates generally to monitoring media content and, more particularly, to methods and apparatus to monitor media content.

### BACKGROUND

Improvements in computerized media presentation devices have expanded the field of devices on which media content may be presented. For example, media content may be presented on desktop computers, laptop computers, tablet computers, mobile computing devices, mobile telephones, etc. Media content producers, content providers, advertisers, media content monitoring entities, and others seek to determine information and statistics about the presentation of media content on such devices.

### BRIEF DESCRIPTION OF THE DRAWINGS

FIG. 1 is a block diagram illustrating a disclosed example system to monitor media content.

FIG. 2 is a block diagram of an example implementation of the meter of FIG. 1.

FIG. 3 is a flowchart representative of example machine readable instructions that may be executed to transmit the meter to the content provider.

FIG. 4 is a flowchart representative of example machine readable instructions that may be executed to request the meter from the media monitoring entity.

FIG. 5 is a flowchart representative of example machine readable instructions that may be executed to transmit the content player and the meter to the content display site.

FIG. 6 is a flowchart representative of example machine readable instructions that may be executed to monitor media content at the content display site.

FIG. 7 is an example processor system that can be used to execute the example instructions of FIGS. 3, 4, 5, and/or 6 to implement the example system of FIG. 1 and/or the meter of FIG. 2.

### DETAILED DESCRIPTION

Example methods, apparatus, and articles of manufacture disclosed herein monitor media content by detecting a code and/or a signature associated with the media content. As used herein a code is data intentionally inserted into or broadcast with the content for the purpose of identifying at least one of the content, a source of the content, a provider of the content, and/or a broadcaster of the content. As used herein, a signature is a representation of some characteristic of the media content (e.g., a frequency spectrum of an audio signal). In some examples, a media content player is transmitted to a content display site. In some such examples, the media content player (e.g., an Adobe® Flash® small web format (SWF) file) is transmitted to the content display site in response to the receipt of a request for the media content from the content display site. In other examples, the media content player is transmitted to the content display site at a time prior to the request for the media content. In some examples, the media content player includes a meter provided by a media monitoring entity. In some examples, the meter is associated with the media content player so that the meter can obtain media content presentation events and identifying information (e.g., codes and/or signatures) about media content presented via the media content player. In some examples, the meter also obtains identifying information about the content display site. In some such examples, the meter transmits obtained information to the media monitoring entity for analysis and/or reporting.

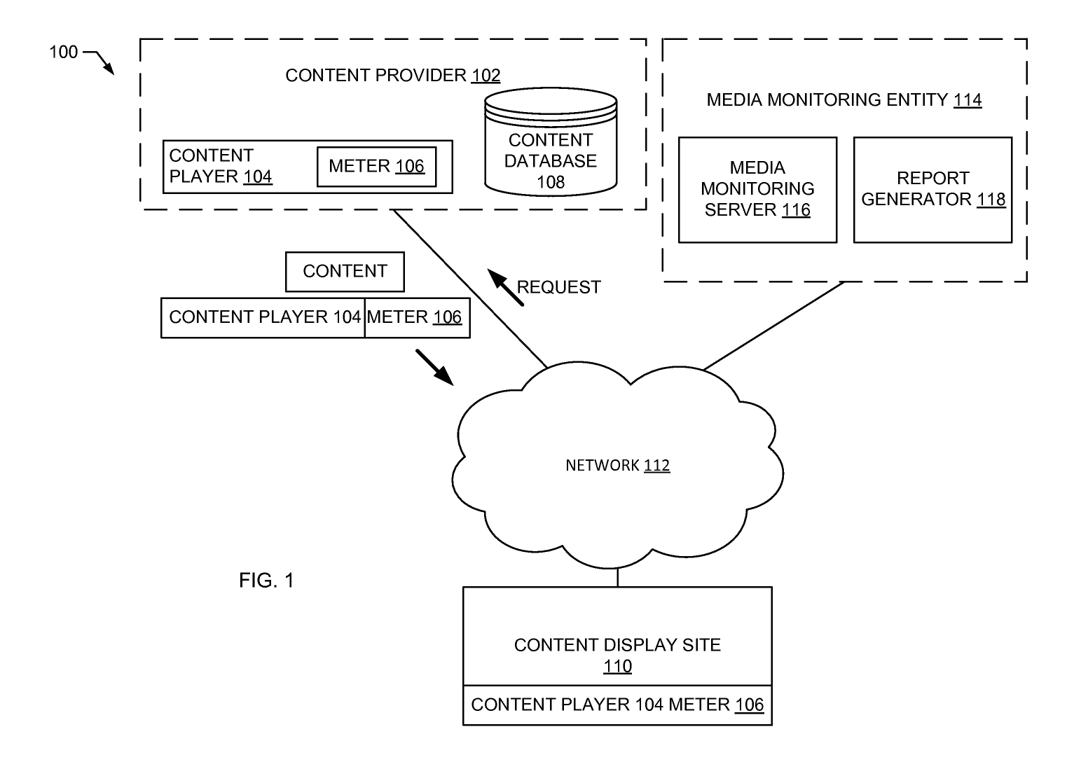

FIG. 1 is a block diagram of an example system 100 to monitor media content. The example system 100 includes a content provider 102, a content display site 110, a network 112, and a media monitoring entity 114.

The content provider 102 of the illustrated example provides media content to the content display site 110 via the network 112. The example content provider 102 may provide any combination of video, audio, text, images, or any other type of media content. In some examples, the content provider 102 may be a social networking site (e.g., Facebook®), a content provider that provides content in connection with a social networking site, or any other type of content provider. Thus, for example, the content provider 102 may provide television programming (e.g., IPTV), movies, radio, internet content, and/or any other type of content.

The example content provider 102 of FIG. 1 provides a content player 104 to the content display site 110 for presenting media content. To illustrate this providing, the content player 104 is shown in FIG. 1 at the content provider site 102, the content display site 110, and in transit between the content provider 102 and the content display site 110. The content player 104 of the illustrated example is a video player capable of presenting audio and/or video content. The content player 104 may additionally or alternatively present any type(s) of media content. The content player 104 may be implemented in any manner. For example, the content player 104 may be implemented in Adobe® Flash® (e.g., provided in a SWF file), may be implemented in hypertext markup language (HTML) (e.g., HTML version 5 (HTML5), may be implemented in Google® Chromium®, may be implemented according to the Open Source Media Framework (OSMF), may be implemented according to a device or operating system provider's media player application programming interface (API), may be implemented on a device or operating system provider's media player framework (e.g., the Apple® iOS® MPMoviePlayer software), etc.

In the illustrated example, the content player 104 executes in an execution environment (e.g., Google Native Client environment, Netscape Plug-in Application Programming Interface (NPAPI), etc.) in a web browser. Alternatively, the content player 104 may execute directly on the content display site 110 (e.g., the Adobe® Flash® execution environment, in the Google Chromium execution environment, the Apple iOS environment, the Google Android™ environment, and the Hewlett Packard webOS environment, etc.), may execute directly in the web browser without the use of an execution environment, or may execute in an execution environment in association with a web browser. In some examples, the content player 104 is a media content player that is not executed in a web browser.

The example content player 104 of FIG. 1 is transmitted to the content display site 110 after the content display site 110 requests media content from the content provider 102. For example, the content player 104 may be transmitted to the content display site 110 in response to a request for presentation of media content from a content display site 110 that does not already have the content player 104 stored at the content display site 110 (e.g., in a storage cache, repository, etc.). Alternatively, the content player 104 may be transmitted to the content display site 110 each time media content is requested (i.e., regardless of whether or not the content display site 110 already stores the content player 104). In other examples, the content player 104 is transmitted at a time not associated with a request for media content from the content display site 110. For example, the content provider 102 may push the content player 104 to the content display site 110 with another product, may transmit the content player 104 in response to a request by the content display site 110 for the content player 104, and/or upon the content display site 110 or a user associated with the content display site 110 signing up for some service and/or group (e.g., joining an audience measurement panel run by, for example, an audience measurement entity). For example, the content display site 110 may request that the content player 104 be transmitted so that the content display site 110 is prepared to receive and present media content at a later time. In some examples, after the content player 104 has been sent to the content display site 110, the content display site 110 may store the content player 104 for later access (e.g., after the content player 104 has been terminated and/or after a web browser or other operating environment has been terminated) and, thus, will not receive the content player 104 in a subsequent transaction with the content provider 102.

The example content player 104 of FIG. 1 obtains media content to be presented from the content provider 102 that provided the content player 104 and/or from other content providers. For example, when the content display site 110 requests presentation of particular media content, the content player 104 and/or the browser in which the content player 104 is executed requests the particular media content from the corresponding content provider (e.g., the content provider 102). For example, the content player 104 may instruct the browser to request the media content. When the requested media content is received from the content provider 102, the content player 104 presents the content at the content display site 110. The content player 104 may include controls for allowing a user to control the presentation of the media content (e.g., pause, play, fast-forward, rewind, etc.). Alternatively, the media content to be presented may be requested from and/or transmitted to the content display site 110 from any other locations (e.g., another server of the content provider 102, a content repository, etc.).

The content player 104 of the illustrated example includes a meter 106 to monitor media content presented by the content player 104. According to the illustrated example, the meter 106 is received from the media monitoring entity 114 and integrated with the content player 104 by the content provider 102. For example, the meter 106 of the illustrated example is a plug-in that is connected with a plug-in interface of the content player 104. For example, the meter 106 may be implemented by computer readable instructions that are instantiated by the content player 104 and/or instantiated by an execution environment within which the content player 104 executes. In some examples, the meter 106 may not include computer readable instructions needed for execution in the absence of the content player 104 and/or other components for executing in an execution environment in which the content player 104 executes. For example, the meter 106 may comprise computer readable instructions that provide an application programming interface (API), a library (e.g., a dynamic link library) of functions, etc. that may be instantiated, called, notified, processed, etc. by the content player 104 and/or the execution environment.

Alternatively, the meter 106 may be one or more instructions provided by the media monitoring entity 114 that are incorporated in the content player 104. Further, the meter 106 may alternatively be provided by a source other than media monitoring entity 114.

In some examples, the meter 106 may terminate when presentation of the media content terminates and/or when the content player 104 terminates. In other examples, the meter 106 may continue monitoring media content after the media content and the content player 104 terminate. For example, where the meter 106 is executing in an execution environment of a web browser, the meter 106 may continue monitoring additional media content that is presented in the web browser and/or at the content display site 110.

The example meter 106 of FIG. 1 is an API with methods, functions, procedures, etc. that may be called by the content player 104 to facilitate monitoring of the media content. For example, the content provider 102 may cause a “play” function of the meter 106 to be called when a play button is selected on the content player 104. Alternatively, the meter 106 may access an API or other interface of the content player 104 to monitor the media content. The meter 106 and the content player 104 may cooperate to facilitate monitoring of the media content. For example, where the meter 106 comprises instructions that are incorporated in the content player 104, the meter 106 and the content player 104 may cooperate to provide the monitoring.

The meter 106 of the illustrated example determines information identifying media content presented at the content display site 110 via the content player 104. In particular, the example meter 106 of FIG. 1 cooperates with the content player 104 to obtain audio presented by the content player 104. The example meter 106 of FIG. 1 analyzes the audio to extract identifying data (e.g., codes also known as watermarks) embedded in or otherwise associated with the audio. The meter 106 may additionally or alternatively collect any other type(s) of identifying data from any part of the media content such as, for example, video watermarks (e.g., identifying information embedded in or otherwise carried in the video content of the media content), signatures (e.g., a proxy representative of a characteristic of a signal associated with the media content), metadata associated with the media content, tags associated with the media content, identifying data transmitted with the media content, identifying data included in a link to the media content, identifying data included in a webpage referencing or referenced by the media content, etc. To collect the identifying data, the meter 106 may access an interface of the content player 104 to obtain the identifying data and/or a portion of the media content including the identifying data. Any technique for collecting identifying data may be used.

The example meter 106 of FIG. 1 also collects identifying information for the content display site 110. According to the illustrated example, the meter 106 retrieves a cookie including identifying information established by the media monitoring entity 114 that identifies the content display site 110. Alternatively, any other identifying information may be collected such as, for example, a signature for devices (e.g., an identification value generated from identification information associated with network interface cards, audio interface cards, etc.) of the content display site 110, a signature of user interactions with the content display site 110 (e.g., keystroke patterns, URL retrieval patterns, etc.), information obtained from a user of the content display site 110 (e.g., via a user input form), demographic information, information identifying the particular user using the content display site 110, etc.

The example meter 106 may also obtain event information from the content player 104. For example, the meter 106 may obtain information indicating that media content presented via the content player 104 was started, that presentation of the media content via the content player 104 was stopped, that media content was fast-forwarded, etc.

The example meter 106 of FIG. 1 transmits the identifying information for the media content, the identifying information for the content display site 110, and/or the event information to the media monitoring entity 114. According to the illustrated example, the meter 106 transmits the information using an HTTP request to an HTTP interface of a media monitoring server 116 of the media monitoring entity 114. For example, the meter 106 may generate a GET or POST request including the identifying information as a parameter of the request. Alternatively, any other method of transmitting the identifying information may be used. The identifying information may be transmitted at any interval. For example, the identifying information may be transmitted as it is generated (e.g., streamed), may be transmitted when a certain amount of identifying information is collected (e.g., a threshold amount of data is detected in a queue), when an available memory space is filled or reaches a threshold capacity (e.g., 90% full), when a particular event is detected (e.g., when presentation of the media content ends, when a new media content is presented, when a certain time of day is detected, etc.), whenever new identifying information is obtained, etc. The meter 106 may transmit identifying information once for each media content or may transmit identifying information multiple times (e.g., every time an event occurs, every time identifying information changes (e.g., when the media content includes codes that change throughout the media content, when a new user is detected, when a change in user is detected, etc.), etc.).

The content database 108 of the illustrated example stores media content. According to the illustrated example, the content provider 102 retrieves the media content from the content database 108 in response to a request from the content player 104 and/or the browser operating at the content display site 110. The content provider 102 transmits the retrieved media content to the content display site 110 for presentation by the content player 104 and, thus, for monitoring by the meter 106. The content database 108 may be any type of data storage device (e.g., a server, a redundant array of independent disks (RAID), etc.).

In the illustrated example, the content provider 102 is implemented by a server including the content player 104, the meter 106, and the content database 108. Alternatively, any of the content player 104, the meter 106, and/or the content database 108 may be stored in one or more separate locations. For example, the content player 104 could be stored at a first location and include a reference to the meter 106 that is retrieved from a second location (e.g., from the media monitoring entity 114). In another example, the content player 104 including the meter 106 may be stored at a first location and the content database 108 may be located at a second location. For example, the content player 104 including the meter 106 may be stored at the media monitoring entity 114. In some examples, the content player 104 may be made available for download by a content display site 110. For example, the content player 104 may be made available for download as an App from the Apple® App Store or any other application repository.

In some examples, the meter 106 may be included in or otherwise delivered with a media content file instead of in the content player 104. In such examples, the meter 106 performs monitoring in connection with the content player 104 when the media content file including the meter 106 is accessed and/or presented by the content player 104. In some examples, the media content file is a SWF flash media file. In such examples, the meter 106 may be included in the SWF flash media file so that the meter 106 is executed when the SWF flash media file is accessed and/or presented by the content player 104.

While a single content provider site 102 a single monitoring entity 114, and a single content display site 110 are illustrated in FIG. 1, any number of content provider sites, monitoring entities, and content display sites may be included in the system 100.

The content display site 110 of the illustrated example is a device that is capable of presenting media content via the content player 104. The content display site 110 may be, for example, a desktop computer, a laptop computer, a mobile computing device, a television, a smart phone, a mobile phone, an Apple® iPad®, an Apple® iPhone®, an Apple® iPod®, an Android™ powered computing device, a Palm® webOS® computing device, etc. While a single content display site 110 is illustrated, any number and/or variety of content display sites may be included in the system 100.

The network 112 of the illustrated example is the internet. Alternatively, any alternative and/or additional network(s) communicatively linking the content provider 102, the content display site 110, and/or the media monitoring entity 114 may be used. The network 112 may comprise any number of public and/or private networks using any type(s) of past, present, and/or future networking protocols.

The media monitoring entity 114 of the illustrated example includes the media monitoring server 116 and a report generator 118. The example media monitoring server 116 of FIG. 1 includes an interface to allow the content display site 110 to transmit monitoring information to the media monitoring entity 114. In the illustrated example, the media monitoring server 116 includes an HTTP interface to receive HTTP requests that include monitoring information. Alternatively, any other method(s) to receive monitoring information may be used. The example media monitoring server 116 of FIG. 1 stores and analyzes monitoring information received from a plurality of different content display sites 110. For example, the media monitoring server 116 may group monitoring information by content provider (e.g., group all monitoring information associated with the content provider 102) by content (e.g., group all monitoring information associated with a particular media content) or in any other fashion.

The media monitoring server 116 of the illustrated example analyzes the monitoring information to eliminate erroneous information. For example, the media monitoring server 116 may compare two types of identifying information received for the same media content (e.g., a metadata tag and an extracted code) to identify discrepancies, may eliminate monitoring information containing discrepancies, and/or may mark certain identifying information as erroneous to be excluded from monitoring information received and/or analyzed at a later time. Any other processing and/or cleansing of monitoring information may additionally or alternatively be performed.

The report generator 118 of the illustrated example analyzes the monitoring information received by the media monitoring server 116 to generate reports about the presentation of media content. For example, the report generator 118 may generate reports indicating the number of times that media content was accessed, the demographics for users that accessed the media content, interactions of users with the media content (e.g., fast forwarding, pausing, etc.), the duration of accesses of the media content, etc. The report generator 118 may, for example, provide a webpage interface through which interested parties can generate custom reports or otherwise access the monitoring information (e.g., for a fee or part of a subscription service). For example, the report generator 118 may generate reports for the content provider 102, for advertisers that distribute advertisements via the content provider 102, for competitors of the content provider 102, etc.

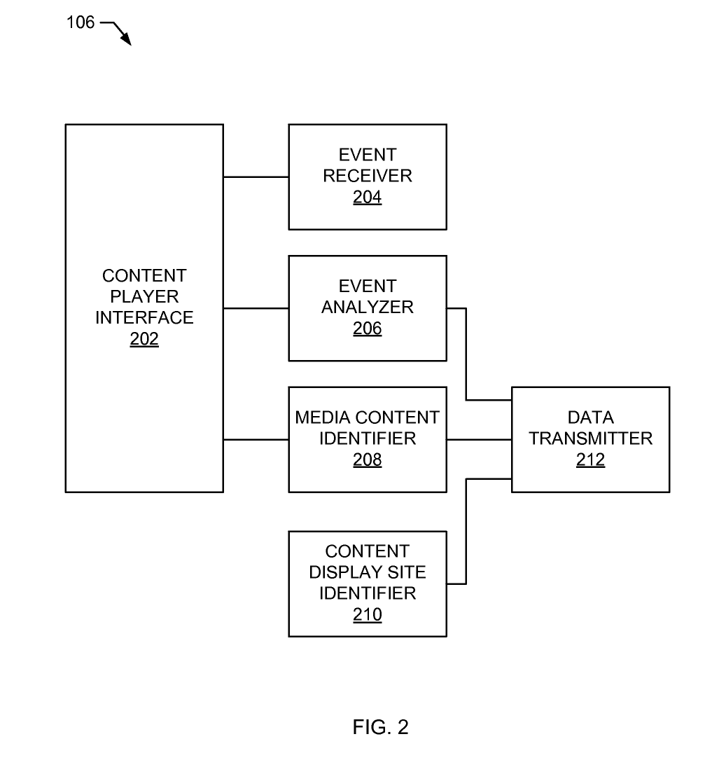

FIG. 2 is a block diagram of an example implementation of the example meter 106 of FIG. 1. The example meter 106 of FIG. 2 includes a content player interface 202, an event receiver 204, an event analyzer 206, a media content identifier 208, a content display site identifier 210, and a data transmitter 212.

The example content player interface 202 provides a communication interface between the content player 104 of FIG. 1 and the meter 106. The content player interface 202 of the illustrated example is an API that enables the content player 104 to access the components of the meter 106 (e.g., the event receiver 204, the event analyzer 206, and/or the media content identifier 208). Alternatively, the content player interface 202 may enable the meter 106 to access an API of the content player 104 or any other interface may be used.

The event receiver 204 of the illustrated example receives notification of media content events from the content player 104. For example, the event receiver 204 may receive an indication when media content presentation begins, when media content presentation ends, when one or more controls of the content player 104 are selected (e.g., fast-forward, rewind, pause, etc.). The event receiver 204 of the illustrated example provides event notifications to one or more of the event analyzer 206, the media content identifier 208, the content display site identifier 210, and/or the data transmitter 212. For example, the event notification may be sent to the components of the meter 106 when operation of any of the components is dependent on the events (e.g., the data transmitter 212 may transmit information in response to an event, the media content identifier 208 may perform media content identification in response to an event, etc.).

The event analyzer 204 of the illustrated example receives information about events from the content player 104 via the content player interface 202 and/or via the event receiver 204. The event analyzer 204 analyzes the events to determine monitoring information regarding the events. For example, the event analyzer 204 may determine the identity of an event, an amount of time that has passed between events (e.g., a duration that a media content is paused), etc. The event analyzer 204 transmits the identifying information to the data transmitter 212 for transmitting to the media monitoring entity 114 of FIG. 1.

The media content identifier 208 of the illustrated example determines identifying information for media content presented by the content player 104. According to the illustrated example, the media content identifier 208 obtains the audio content of the media content via the content player interface 202 and analyzes the audio content to extract identifying codes embedded in the media content and signatures of the media content. Alternatively, any other identifying information may be extracted, generated, and/or identified. Multiple types of identifying information may be extracted. The identifying information is transmitted to the data transmitter 212 for transmitting to the media monitoring entity 114 of FIG. 1.

The content display site identifier 210 of the illustrated example determines identifying information for the content display site 110 on which the content player 104 is operating. According to the illustrated example, the content display site identifier 210 retrieves a cookie storing identifying information for the content display site. Alternatively, any other type of identifying information may be used. A user identifier may be obtained or generated. For example, a user and user identifier may be determined based on a prompt of the user to input identifying information (e.g., a login), a camera, user mannerisms, usage patterns (e.g., URL selections), etc. The content display site identifier 210 transmits the identifying information (e.g., the identifying information for the content display site 110 and/or the user identifier) to the data transmitter 212 for transmitting to the media monitoring entity 114 of FIG. 1.

The data transmitter 212 of the illustrated example receives event information from the event analyzer 206, identifying information for media content from the media content identifier 208, and identifying information for the content display site 110 from the content display site identifier 210 and transmits the information to the media monitoring entity 114 of FIG. 1. The data transmitter 212 of the illustrated example transmits the information using, for example, an HTTP request that includes the information as one or more parameters of the HTTP request. Alternatively, any other method of transmitting the information may be used.

While example manners of implementing the system 100 of FIG. 1 and the meter 106 of FIGS. 1 and/or 2 have been illustrated, one or more of the elements, processes and/or devices illustrated in FIG. 1 and FIG. 2 may be combined, divided, re-arranged, omitted, eliminated and/or implemented in any other way. Further, the content provider 102, the content player 104, the meter 106, the content database 108, the content display site 110, the network 112, the media monitoring entity 114, the media monitoring server 116, and the report generator 118 of FIG. 1 and the content player interface 202, the event receiver 204, the event analyzer 206, the media content identifier 208, the content display site identifier 210, and the data transmitter 212 of FIG. 2 may be implemented by hardware, software, firmware and/or any combination of hardware, software and/or firmware. Thus, for example, any of the content provider 102, the content player 104, the meter 106, the content database 108, the content display site 110, the network 112, the media monitoring entity 114, the media monitoring server 116, and the report generator 118 of FIG. 1 and the content player interface 202, the event receiver 204, the event analyzer 206, the media content identifier 208, the content display site identifier 210, and the data transmitter 212 of FIG. 2 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the content provider 102, the content player 104, the meter 106, the content database 108, the content display site 110, the network 112, the media monitoring entity 114, the media monitoring server 116, and the report generator 118 of FIG. 1 and the content player interface 202, the event receiver 204, the event analyzer 206, the media content identifier 208, the content display site identifier 210, and the data transmitter 212 of FIG. 2 are hereby expressly defined to include a tangible computer readable medium such as a memory, DVD, CD, etc. storing the software and/or firmware. Further still, the example system 100 of FIG. 1 and/or the meter 106 of FIG. 2 may include one or more elements, processes and/or devices in addition to, or instead of, those illustrated in FIG. 1 and FIG. 2, and/or may include more than one of any or all of the illustrated elements, processes and devices.

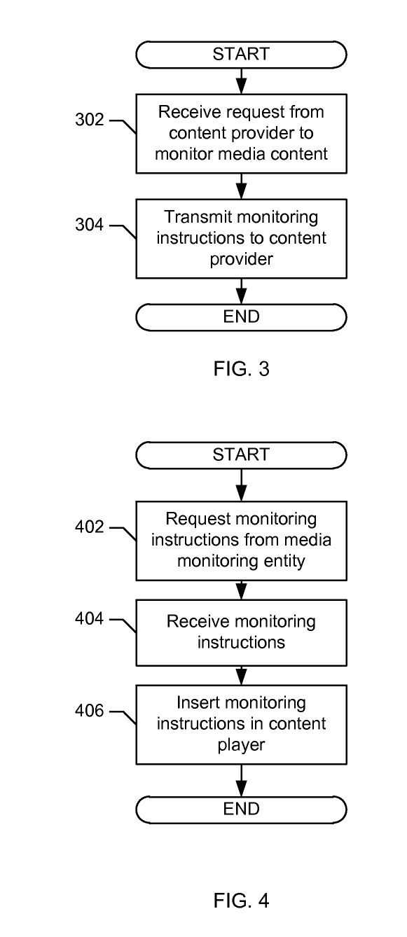

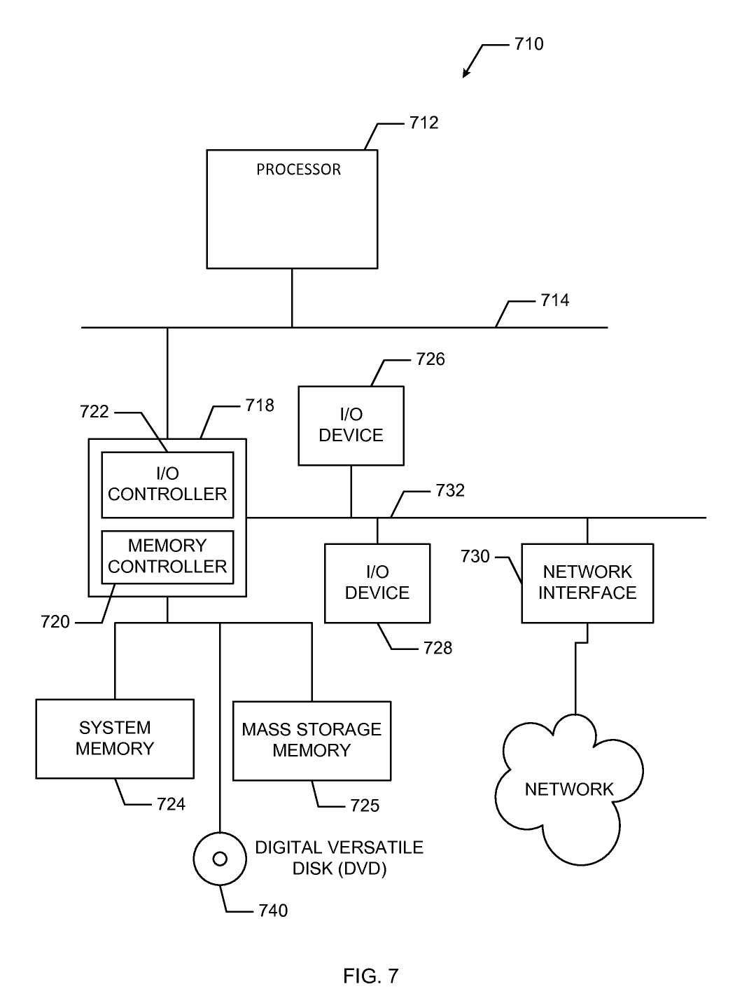

FIGS. 3-6 are flow diagrams representative of example machine readable instructions that may be executed to implement the example system 100 of FIG. 1 and the meter 106 of FIG. 2. In this example, the machine readable instructions comprise a program for execution by a processor such as the processor 712 shown in the example computer 700 discussed below in connection with FIG. 7. The program may be embodied in software stored on a computer readable medium such as a CD-ROM, a floppy disk, a hard drive, a digital versatile disk (DVD), or a memory associated with the processor 712, but the entire program and/or parts thereof could alternatively be executed by a device other than the processor 712 and/or embodied in firmware or dedicated hardware. Further, although the example program is described with reference to the flowchart illustrated in FIGS. 3-6, many other methods of implementing the example system 100 may alternatively be used. For example, the order of execution of the blocks may be changed, and/or some of the blocks described may be changed, eliminated, or combined.

As mentioned above, the example processes of FIGS. 3-6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information).

As used herein, the term tangible computer readable medium is expressly defined to include any type of computer readable storage and to exclude propagating signals. Additionally or alternatively, the example processes of FIGS. 3-6 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, the example processes of FIGS. 3-6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, the example processes of FIGS. 3-6 may be implemented as any combination(s) of any of the foregoing techniques, for example, any combination of firmware, software, discrete logic and/or hardware.

Although the example processes of FIGS. 3-6 are described with reference to the flow diagrams of FIGS. 3-6, other methods of implementing the processes of FIGS. 3-6 may be employed. For example, the order of execution of the blocks may be changed, and/or some of the blocks described may be changed, eliminated, sub-divided, or combined. Additionally, one or more of the example processes of FIGS. 3-6 may be performed sequentially and/or in parallel by, for example, separate processing threads, processors, devices, discrete logic, circuits, etc.

While FIGS. 3-6 are described with reference to the system 100 of FIG. 1 and the meter 106 of FIG. 2, any other components may implement and/or be implemented by the flow diagrams of FIGS. 3-6.

Turning in detail to FIG. 3, initially, the media monitoring entity 114 receives a request from the content provider 102 to monitor media content (block 302). For example, the media monitoring entity 114 may provide a webpage interface that allows a content provider 102 to request monitoring. Alternatively, the media monitoring entity 114 may receive the request via an electronic message, a telephone call, physical mail, etc. In some examples, the media monitoring entity 114 and the content provider 102 may reach an agreement regarding a cost for the media monitoring entity 114 to provide the meter 106 and/or provide media monitoring data to the content provider 102. Alternatively, the media monitoring entity 114 may provide an incentive for the content provider 102 to include the meter 106 in the content player 104 (e.g., a monetary incentive such as a payment or a discount). The media monitoring entity 114 may create an account for the content provider 102 in systems of the media monitoring entity 114 (e.g., in the media monitoring server 116).

In response to the request (block 302), the media monitoring entity 114 transmits monitoring instructions (e.g., the meter 106) to the content provider 102 (block 304). The monitoring instructions may be customized by the media monitoring entity 114 (e.g., by inserting identifying information for the content provider 102 such as an account identifier in the monitoring instructions) or may need to be customized by the content provider 102. The monitoring instructions may be transmitted electronically or may be sent to the content provider 102 on a physical medium. In some examples, an agent of the media monitoring entity 114 may access a server or system of the content provider 102 to provide the meter 106 to the content provider 102 (e.g., the agent may install the meter 106 in the content player 104).

Turning in detail to FIG. 4, initially, the content provider 102 requests that the media monitoring entity 114 provide the content provider 102 with monitoring instructions (e.g., the meter 106) (block 402). For example, the request may be the same request discussed in connection with block 302 of FIG. 3. The content provider 102 may provide identifying information to the media monitoring entity 114 for establishing an account with the media monitoring entity 114.

In response to the request (block 402), the content provider 102 receives the monitoring instructions (e.g., the meter 106) (block 404). The content provider 102 then inserts the monitoring instructions in the content player 104 (block 406). As part of inserting the monitoring instructions in the content player 104, the content provider 102 may customize the monitoring instructions. For example, the content provider 102 may insert identifying information for the content provider 102 such as account information received from the media monitoring entity 114. The content provider 102 may also customize the monitoring instructions to work with the content player 104. For example, the content provider 102 may insert the names of methods, functions, procedures, etc. of the content player 104 in the monitoring instructions. The content provider may also customize the content player 104 to work with the monitoring instructions. For example, the content provider 102 may insert the names of methods, functions, procedures, etc. of the monitoring instructions in the content player 104. In some examples, the content provider 102 may compile, package, or bundle the content player 104 and the monitoring instructions. For example, the content provider 102 may insert the monitoring instructions in the content player 104 and then compile the content player 104 including the monitoring instructions to generate an executable file.

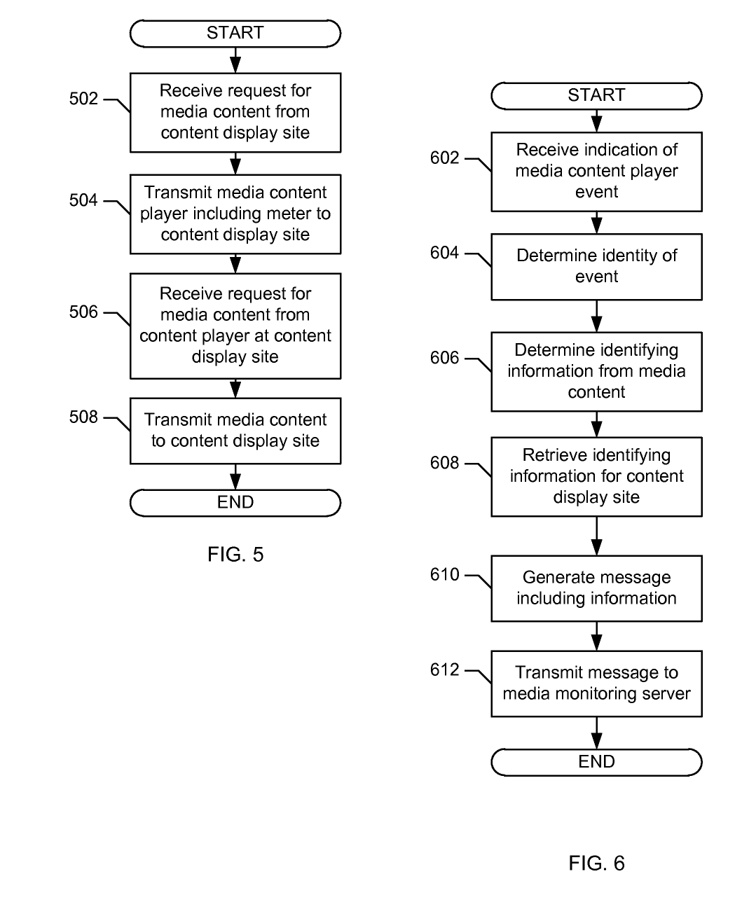

Turning in detail to FIG. 5, initially, the content provider 102 receives a request for media content from the content display site 110 (block 502). In response to the request, the content provider 102 transmits the content player 104 including the meter 106 to the content display site 110 (block 504). According to the illustrated example, the content provider 102 then receives a request for the media content from the content player 104 operating at the content display site 110 (block 506). The content provider 102 then retrieves the requested media content from the content database 108 and transmits the media content to the content display site 110 for presentation by the content player 104 (block 508).

Turning in detail to FIG. 6, initially, event receiver 204 receives an indication of a media content player event via the content player interface 202 of the meter 106 (block 602). For example, the process of FIG. 6 may be initiated when an indication that media content presentation has been initiated by the content player 104 is received by the event receiver 204. The event analyzer 206 determines the identity of the event (block 604). The media content identifier 208 determines the identity of the media content (block 606). For example, the media content identifier 208 may extract a code embedded in or otherwise associated with the media content, may generate a signature for the media content, may extract metadata associated with the media content, and/or may collect any other information associated with the media content. For example, the media content identifier 208 may determine an identity of a creator of the media content, a creation date of the media content, a timestamp of a last key frame of the media content, a last timestamp encoded in the media content, a width of a display of the media content, a frequency of audio contained in the media content, an encoding format of the media content, an encoding depth of the media content, a number of channels of audio in the media content, a timestamp for a code embedded in audio content of the media content, a file time for a code embedded in audio content of the media content, a source identifier for a code embedded in the media content, a level of audio content in the media content, a content index for a code embedded in the media content, an audio code identifier, an audio data rate, an audio delay, an audio size, a creation date of the media content, a data size of the media content, a file size of the media content, an identification of a metadata creator of the media content, a date associated with metadata of the media content, a video code content identifier (CID), a video data rate, a video size, an added tag, and/or any other information included in or otherwise associated with the media content.

The content display site identifier 210 then determines an identity of the content display site 110 (block 608). The data transmitter 212 generates a message that includes the monitoring information such as, for example, the event information, media content information, and/or content display site identifying information (block 610). For example, the request may be an HTTP request that includes the monitoring information. The data transmitter 212 of the meter 106 then transmits the message to the media monitoring server 116 of the media monitoring entity (block 612). According to the illustrated example, the data transmitter 212 transmits an HTTP request with monitoring information included in HTTP GET or POST fields. The request may specify a resource that does not exist at the media monitoring server 116; however, the media monitoring entity extracts the monitoring information from the HTTP request.

According to the illustrated example, the process of FIG. 6 terminates after the message is transmitted to the media monitoring server 114. Alternatively, control may return to one of block 604, block 606, or block 608 to continue monitoring media content presentation by the content player 104.

FIG. 7 is a block diagram of an example processor system 710 that may be used to execute the example instructions of FIGS. 3-6 to implement the example apparatus, methods, and/or systems described herein. As shown in FIG. 7, the processor system 710 includes a processor 712 that is coupled to an interconnection bus 714. The processor 712 may be any suitable processor, processing unit, or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. A chipset provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724, a mass storage memory 725, and/or a digital versatile disk (DVD) 740.

In general, the system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc. The computer-readable instructions represented by the flow charts described above may be stored in the system memory 724, the mass storage memory 725, and/or the DVD 740.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a digital subscriber line (DSL) modem, a cable modem, a cellular modem, etc. that enables the processor system 710 to communicate with another processor system.

While the memory controller 720 and the I/O controller 722 are depicted in FIG. 7 as separate functional blocks within the chipset 718, the functions performed by these blocks may be integrated within a single semiconductor circuit or may be implemented using two or more separate integrated circuits.

Although the above discloses example methods, apparatus, systems, and articles of manufacture including, among other components, firmware and/or software executed on hardware, it should be noted that such methods, apparatus, systems, and articles of manufacture are merely illustrative and should not be considered as limiting. Accordingly, while the above describes example methods, apparatus, systems, and articles of manufacture, the examples provided are not the only ways to implement such methods, apparatus, systems, and articles of manufacture.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method comprising:
transmitting a meter to a content provider, the meter implemented by computer readable instructions to be executed with a media content player when media content is presented by the media content player, the meter to:
at least one of generate a signature for the media content and extracting a code from the media content; and
transmit at least one of the signature and the code to a media monitoring entity.

2. A method as in claim 1, further comprising instructing the content provider to transmit the meter to a content display location that is to present the media content from the content provider.

3. A method as in claim 1, wherein the media monitoring entity is not the content display site.

4. A method as in claim 1, wherein the media content player and the meter operate in a web browser.

5. A method as in claim 1, wherein the media content player and the meter operate in an operating environment in a web browser.

6. A method as in claim 1, wherein the meter continues to operate after the media content player is terminated.

7. A method as in claim 6, wherein the meter is to at least one of generate a second signature for second media content and extract a second code from the second media content.

8. A method as in claim 7, wherein the second media content is provided by a second content provider that is different from the content provider.

9. A method as in claim 1, wherein the meter is to transmit the at least one of the signature, and the code to the media monitoring entity by sending a hypertext transport (HTTP) request to the media monitoring entity, the HTTP request to include data representative of the at least one of the signature, and the code.

10. A method as defined in claim 1, wherein the meter comprises an application programming interface.

11. A method as in claim 1, wherein the meter remains at the content display site after a web browser is terminated.

12. A meter comprising:
a content player interface to receive an instantiation from a media content player;
a media content identifier to at least one of generate a signature for the media content and extract a code from the media content; and
a data transmitter to transmit at least one of the signature and the code to a media monitoring entity.

13. An apparatus as in 12, further comprising a content display site identifier to determine identifying information for the content display site, the data transmitter to transmit the identifying information to the media monitoring entity.

14. An apparatus as in 12, further comprising:
an event receiver to receive event data from the content player for a presentation of media content; and
an event analyzer to analyze the event data to determine event information about the presentation of the media content.

15. An apparatus as in 14, wherein the data transmitter is to transmit event the information about the presentation of the media content to the media monitoring entity.

16. An apparatus as in claim 15, wherein the event information about the presentation of the media content includes at least one of a duration of time that the media content is presented and information about an interaction with the media content.

17. A tangible computer readable medium storing instructions that, when executed, cause a machine to at least:
transmit a meter to a content provider, the meter implemented by computer readable instructions to be executed with a media content player when media content is presented by the media content player, the meter to:
at least one of generate a signature for the media content and extract a code from the media content; and
transmit at least one of the signature and the code to a media monitoring entity.

18. A tangible computer readable medium as in claim 17, wherein the instructions, when executed, cause the machine to instruct the content provider to transmit the meter to a content display location that is to present the media content from the content provider.

19. A tangible computer readable medium as in claim 17, wherein the media monitoring entity is not the content display site.

20. A tangible computer readable medium as in claim 17, wherein the media content player and the meter operate in a web browser.

21. A tangible computer readable medium as in claim 1, wherein the media content player and the meter operate in an operating environment in a web browser.

22. A tangible computer readable medium as in claim 1, wherein the meter continues to operate after the media content player is terminated.

23. A tangible computer readable medium as in claim 6, wherein the meter is to at least one of generate a second signature for second media content and extract a second code from the second media content.

24. A tangible computer readable medium as in claim 7, wherein the second media content is provided by a second content provider that is different from the content provider.

25. A tangible computer readable medium as in claim 1, wherein the meter is to transmit the at least one of the signature, and the code to the media monitoring entity by sending a hypertext transport (HTTP) request to the media monitoring entity, the HTTP request to include data representative of the at least one of the signature, and the code.

26. A tangible computer readable medium as defined in claim 1, wherein the meter comprises an application programming interface.

27. A tangible computer readable medium as in claim 1, wherein the meter remains at the content display site after a web browser is terminated.
